(19) United States
(12) Patent Application Publication
(10) Pub. No.: US 2015/0068897 A1
(43) Pub. Date: Mar. 12, 2015

(54) CAPACITIVE SENSING DEVICE INCORPORATING A METAL STRIP ON A TRANSPARENT GUARD

(71) Applicant: FOGALE NANOTECH, Nimes (FR)

(72) Inventors: Christian Neel, Nimes (FR); Christophe Blondin, Nimes (FR)

(21) Appl. No.: 14/387,024

(22) PCT Filed: Mar. 22, 2013
(86) PCT No.: PCT/EP2013/056078

§ 371 Date: Sep. 22, 2014

(30) Foreign Application Priority Data
Mar. 23, 2012 (FR) 1252619

(51) Int. Cl. G01N 27/416

(52) U.S. Cl. CPC G01N 27/416
USPC 204/407

(57) ABSTRACT

A human-machine interface device is provided having a transparent area for viewing a display screen and an access area including at least one metal connector connected to at least two planes arranged above the display screen, the planes including an electrode plane made of a transparent resistive conductive material, the plane located in the transparent area, a conductor plane made of a transparent resistive conductive material used as an active guard for the electrode plane, the active guard located in the transparent area and extending into the access area. The present device includes at least one guard strip, for reducing the resistance of the guard, the guard strip being arranged within the access area and connected to the active guard and to the metal connector, the latter being connected to the electrode plane such that the conductor plane and the electrode plane are at substantially the same potential.

The present invention relates to a device for capacitive measurement between an object and a plane of electrodes. It finds its application in particular in the general field of 2D capacitive touch surfaces and 3D capacitive detection used for human-machine interface commands.

Increasingly, devices used for communication and for work utilize a touch command interface such as a pad or a screen. There can be mentioned for example mobile phones, smartphones, electronic notebooks, PC, mice, touch screens, widescreens, etc.

A large number of these interfaces utilize capacitive technologies. The touch surface is equipped with conductive electrodes linked to electronic means making it possible to measure the variation of the capacitances created between electrodes and the object to be detected in order to perform a command.

The current capacitive techniques most frequently utilize two layers of conductive electrodes in the form of rows and columns. The electronics measure the capacitive couplings existing between these rows and columns. When a finger is very close to the active surface, the capacitive couplings close to the finger are altered and the electronics can thus locate the 2D position (XY) in the plane of the active surface.

This technology makes it possible to detect the presence and the position of the finger through a dielectric. This technique has the advantage of obtaining a very high resolution on the location in the plane XY of the sensitive surface of one or more fingers. These technique nevertheless have the drawback of only detecting a contact with the object or detection in very close proximity but not exceeding a few mm. It is difficult to perform touch commands with thick gloves (ski gloves, motorcycle gloves, etc.), with long fingernails or with a stylus. The low sensitivity of the capacitive electrodes does not allow a command to be initiated through a thick dielectric.

There are also more recent techniques allowing measurement of the absolute capacitance created between the electrodes and the object to be detected. This technique is similar to the technique known as self-capacitance. There can be mentioned for example patent FR2756048: Floating capacitive measuring bridge, patent FR2893711: Device and Method for Capacitive Measurement by a Floating Bridge, or patent FR2844349: Proximity Detector Comprising Capacitive Sensor. These techniques make it possible to obtain a measurement of the inter electrode-object capacitance that has a very high resolution and to detect for example a finger at several cm or even at 10 cm distance. The spatial detection takes place in 3 dimensions XYZ but also by touch within the plane XY. This time it is possible to initiate a command with a glove or through any type of thick dielectric. However, a new problem becomes apparent with respect to the contact measurement techniques (touch surface) at the level of the capacitive value to he measured. In fact, with the current capacitive techniques of the row column type, the capacitive value is of the order of one pF, while with the recent techniques the inter-electrode capacitance is of the order of one W. For this reason it is necessary to add a shielding layer, called a guard, in order to reduce stray capacitances.

In the current devices the layers of electrodes must be made from transparent materials and are incorporated as close to the screen as possible (linked to the ground potential) in order to reduce the thickness of the device. These are made from ITO. Conventionally, ITO has a resistivity between 50 ohm/square and 200 ohm/square. The incorporation of the guard plane very close to the ground (screen) produces a strong capacitive coupling between the guard and the ground. This strong capacitive coupling associated with the high resistivity of the ITO material creates capacitive and resistive leakage (quadrature) that is significant for measurement. In a first-order equivalent diagram, an RC network is shown. The capacitive coupling results from the mechanical assembly of the device and from the surfaces of the screen and guard plane. It is therefore difficult to change.

Document US2010/052700 is known, describing a guard plane in parallel with the electrode plane intended for the detection. The guard plane is designed to reject external noise. Document EP2420918 also describes a plane for intercepting external noise by means of a metal strip. Document US2011/169783 describes a touch screen comprising a detection plane and a guard plane linked to ground. The purpose of the present invention is to overcome the drawbacks of the prior art by proposing a novel device for limiting leakage currents.

The above-mentioned objective is achieved with a human-machine interface device that has, in particular in front view, a transparent area for viewing a display screen and an access area where there is at least one metal link connected to at least two planes arranged over the display screen, these planes being:
an electrode plane made from resistive conductive transparent material, this plane being present in the transparent area,
a conductive plane made from resistive conductive transparent material, used as an active guard or shield for the electrode plane, this active guard being present in the transparent area and extending into the access area. According to the invention, the device comprises at least one metal strip, called guard strip, for reducing the resistivity of the guard, this guard strip being:
connected to said metal link and to the active guard, and
arranged in the access area.

With such a device, the guard is connected to a metal strip in order to render it sufficiently conductive and to guarantee its effectiveness. Preferably this strip is arranged on a face of the guard, in particular on the face opposite the electrode plane. The method of implementation of this metal strip is compatible with the industry concerned. This metal strip can be complete, as a closed frame around the transparent area, or on one or more of the sides only, according to the desired resistivity level.

Preferably, the access area is an area not visible from the outside. Generally, phone manufacturers in particular define a opaque, non-visible area at the periphery of the transparent area, in which the metal connections running under this area are not visible from the outside.

Advantageously, the electrode and guard planes are designed from the indium-doped tin oxide (ITO). Other transparent materials such as aluminium-doped zinc oxide (AZO) or tin-doped cadmium oxide can also be used.

According to the invention, the metal link can be a ribbon cable originating from an electronic control circuit.

According to an advantageous feature of the invention, the conductor plane is a guard according to a floating-point technology.

Advantageously, the transparent area is a touch area for the detection of an object. This can be a 3D detection in a volume close to the electrodes.

The metal strip can be made from silver, but other materials can be used.

Other advantages and characteristics of the invention will become apparent on examination of the detailed description of an embodiment which is in no way limitative, and the attached drawings in which:

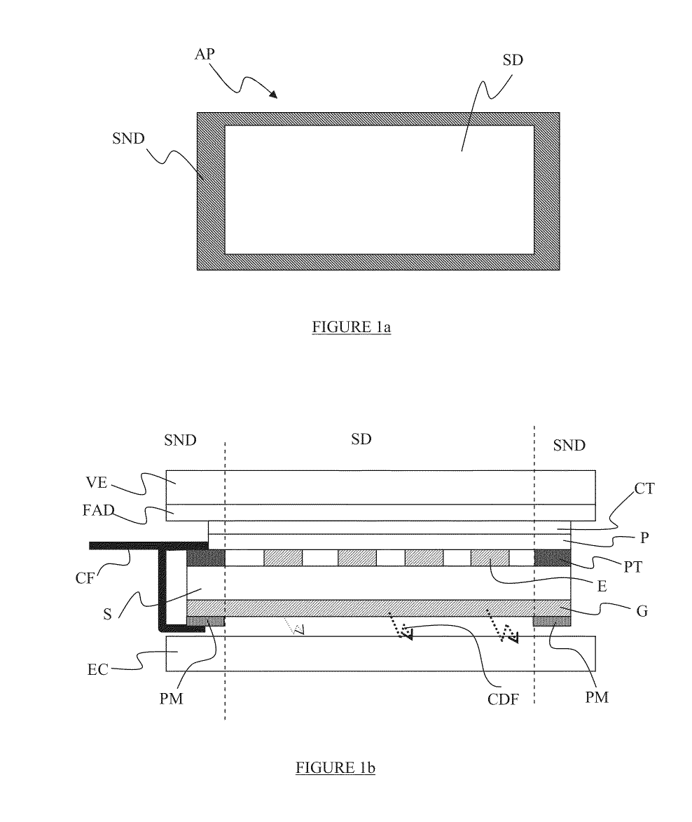

FIGS. 1a and 1b are diagrammatic views of a device according to the invention;

FIG. 2 is a diagrammatic view showing capacitive charge leakages due to the resistive character of the electrodes and of the guard; and

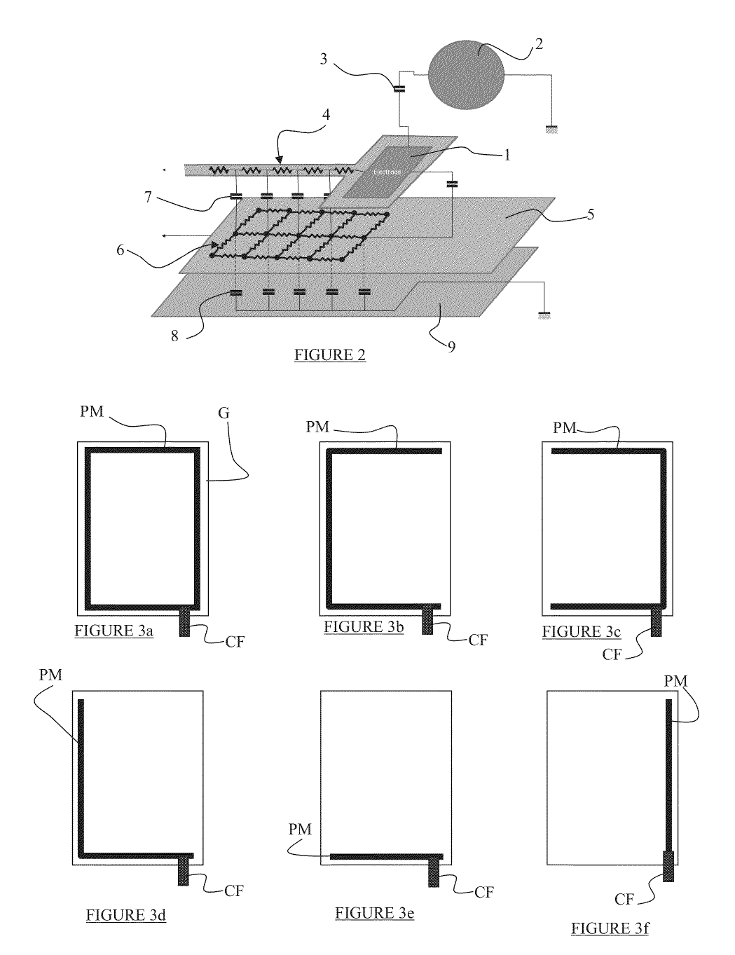

FIGS. 3a to 3f show examples of arrangements of the metal strip.

In general terms, FIGS. 1a and 1b show a device AP according to the invention. This can be a phone of the “smartphone” type or a digital tablet equipped with a touch screen. This device AP comprises a detection surface SD which is the touch part under which is located in particular a (flat or curved) plane of electrodes. This detection surface SD comprises, starting from the upper portion, several layers made from a transparent material such as for example:
an outer glass VE,
an anti-debris film FAD,
a transparent bond CT, and
a polariser P,
electrodes E made from conductive transparent material such as tin-doped indium oxide (ITO),
a glass support S for electrodes,
a guard G which is a layer made from conductive transparent material such as tin-doped indium oxide (ITO),
a display screen EC which must be visible from the outside from the outer glass VE.

The electrodes and the guard are therefore under the detection surface and are made from conductive transparent material which has a high resistivity.

A non-detection surface SND is also distinguished which in the case in point surrounds the detection surface SD. This surface is generally opaque from the outside and does not have electrodes but connecting strip PT and flexible links CF which are made from metal, therefore having almost no resistivity.

The high resistivity of the conductive transparent material can be problematic (in the presence or not of the guard G) because a coupling between this resistive material and the screen which is generally grounded to the device can take place. The electrodes (and the guard) must be substantially at one and the same potential (different to that of the screen) over the entire plane (electrodes plane and/or guard plane). When coupling exists with the screen, leakage currents CDF exist and become more intense as they become more distant from the metal connections (PT, CF). Thus the coupling between the conductive transparent material (electrodes and/or guard) and the screen becomes very much greater than the coupling that it is sought to measure between the electrodes and the object of interest, assumed to he over the outer glass.

According to the invention, a metal strip PM is provided in the form of a frame surrounding the entire transparent area. This is a silver strip pressed against the rear face of the guard G but only in the non-transparent area. This strip PM is connected to the flexible connector CF which provides a potential substantially identical to that of the guard G.

FIG. 2 shows a diagram illustrating the leakage capacitances. Electrode plane 1 can be distinguished, for detecting the positioning of an object 2 by measuring the capacitance 3 (Ctarget) between them. It is assumed that the object 2 is grounded. The electrodes are designed based on ITO which has a high resistivity. The latter is represented by a series of resistances 4.

The guard plane 5 is also resistive because it contains ITO. This resistivity is represented by a network of resistances 6. Charge leakage currents 7 exist between the resistances 4 and the resistances 6. Moreover, leakage capacitances 8 also exist between the resistances 6 and a ground plane 9 (generally the display screen of the device).

FIGS. 3a to 3f show the rear face of the guard G, i.e. the face opposite the electrodes. Several arrangements are possible. FIG. 3a shows a preferred arrangement for which the metal strip PM is a closed frame. In FIGS. 3b and 3c, the metal strip PM is C-shaped, open in one part but still connected to the connector CF. In FIG. 3d, this is an L shape, and in FIGS. 3e and 3f, it is a single horizontal or vertical bar.

Of course, the invention is not limited to the examples that have just been described and numerous adjustments can be made to these examples without exceeding the scope of the invention.

1. A human-machine interface device having a transparent area for viewing a display screen and an access area where there is at least one metal link connected to at least two planes arranged over the display screen, comprising:
said planes being:
an electrode plane made from transparent resistive conductive material, this plane being present in the transparent area;
a conductive plane made from transparent resistive conductive material, used as an active guard for the electrode plane, this active guard being present in the transparent area and extending into the access area;
said device further including at least one guard strip, for reducing the resistivity of the guard, this guard strip being:
connected to the active guard;
connected to said metal link, the latter being connected to the electrode plane so that the conductor plane and the electrode plane are substantially at one and the same potential; and
arranged in the access area.

2. The device according to claim 1, characterized in that the metal strip is a closed frame surrounding the transparent area.

3. The device according to claim 1, characterized in that the access area is an area that is not visible from the outside.

4. The device according to claim 1, characterized in that the electrodes plane and the active guard are designed from tin-doped indium oxide.

5. The device according to claim 1, characterized in that the metal strip is arranged on one face of the active guard.

6. The device according to claim 5, characterized in that the metal strip is arranged on the opposite face to the electrode plane.

7. The device according to claim 1, characterized in that the metal link is a ribbon cable originating from an electronic control circuit.

8. The device according to claim 1, characterized in that the conductor plane is a guard according to a floating-point technology.

9. The device according to claim 1, characterized in that the transparent area is a touch area.

10. The device according to claim 1, characterized in that the metal strip is made from silver.
